(19) United States
(12) Patent Application Publication
(10) Pub. No.: US 2001/0045510 A1
(43) Pub. Date: Nov. 29, 2001

(54) Method of adjusting an optronic fuse system

(75) Inventor: Andreas Ganghofer, Nurnberg (DE)

Correspondence Address: Leopold Presser, Esq., Scully, Scott, Murphy & Presser, 400 Garden City Plaza, Garden City, NY, 11530, US

(73) Assignee: Diehl Munitionssysteme GmbH & Co. KG, Rothenbach (DE)

(21) Appl. No.: 09/864,992

(22) Filed: May 24, 2001

(30) Foreign Application Priority Data
May 25, 2000 (DE) 100 25 962.6

(51) Int. Cl. H01J 40/14

(52) U.S. Cl. 250/214 R

(57) ABSTRACT

Described is a method of adjusting the sensitivity of and stabilising an optronic fuse system which has a controller and as the receiver an avalanche photodiode (APD). In order to avoid adjustment of an analog electronic system with potentiometers, laser trimming or individual resistor fitment, the controller ascertains the temperature of the APD and regulates the bias voltage of the APD in such a way that the sensitivity of the APD corresponds to its reference sensitivity at any temperature.

The invention concerns a method of adjusting the sensitivity of and stabilising an optronic fuse system, as set forth in the classifying portion of claim 1.

Optronic fuse systems are known per se in various configurations. For example DE 24 56 162 C2 discloses a missile fuse with an opto-electronic measuring device which, upon reaching a given range between the missile and a target surface, delivers a signal to an evaluation circuit. That known measuring device has a transmitter which emits optical pulses at a pulse repetition frequency through a lens and a receiver which is arranged at a given spacing from the transmitter and which records portions of those optical pulses, which are returned from the target surface by way of a further lens, with a narrow-band filter which is tuned to the pulse repetition frequency, and a receiving amplifier. To eliminate the effects of circuitry-induced frequency deviations, connected between the band pass filter and the transmitter is a regulating circuit by which the pulse repetition frequency of the transmitter tracks the centre frequency of the band pass filter. The input signal of the regulating circuit is a signal which is filtered out of the noise level of the receiving amplifier by the band pass filter.

An optical range sensor for a missile fuse is described in DE 26 08 066 C2, which operates on the basis of the pulse reflection principle and which in the reception branch has in series an amplifier, a gate circuit which is opened in the transmission pulse cycle, an integrating capacitor circuit and a threshold switch. Arranged in the reception branch of that optical range sensor, upstream of the gate circuit, is a high pass filter whose limit frequency is slightly below the transmission pulse repetition frequency. The integrating capacitor circuit is connected in such a way that it sums positive and negative signal components in accordance with the sign thereof.

An adjusting device on opto-electronic proximity fuses is known from DE 27 14 766 C2 wherein arranged in mutually juxtaposed relationship in the head of the fuse are the optical systems of a transmitter provided with a directional antenna or emission device of small area, and a light receiver provided with a radiation detector which is also of small area, whose light characteristics which are afforded by optical lenses can be adjusted in such a way that the beams thereof cross at a reference or target distance from the fuse head. In that case, the beam transmitter and the beam receiver are each arranged on a respective slider which is disposed transversely displaceably on a disc-shaped carrier plate. The two carrier plates are in turn supported in mounting bodies which are each rotatable about the optical axis of the associated lens, which extends through the associated carrier plate, and can be arrested after adjustment has been effected.

DE 39 18 243 C2 discloses an optronic proximity fuse which responds to a reflection amplitude being exceeded and which has an adjustable mechanical aperture member in its beam path to be reflected at a target surface, comprising transmission and reception characteristics. The aperture member is designed for triggering threshold fine adjustment or calibration after coarse adjustment of the transmitter and the receiver and is in the form of a pin-shaped shading element which engages transversely with respect to the beam path to a greater or lesser depth into one of the characteristics.

An optronic fuse in particular for a large-calibre aerial bomb is described in DE 39 27 819 C2.

The object of the present invention is to provide a method of the kind set forth in the opening part of this specification, in which manual adjustment or calibration is eliminated so that the optronic fuse system, that is to say the optronic proximity fuse, is possible with a design which is appropriate for manufacture.

In accordance with the invention, in a method of the kind set forth in the opening part of this specification, that object is attained by the features of the characterising portion of claim 1. Preferred developments of the method according to the invention are characterised in the appendant claims.

Optronic fuses which have to comply with a narrow sensitivity range hitherto suffer from the problem that they have to be manually adjusted and calibrated. That adjustment operation is effected for example by setting potentiometers which are provided for that purpose or by laser trimming, in particular in large-scale mass production or by individual resistor fitment, in particular in small-scale series production.

The overall sensitivity of the optronic fuse system is determined by the output of the transmitter and the level of sensitivity of the receiver and by the gain of the amplifier chain of the system. If the firing system is to have a narrow reference sensitivity, then that overall sensitivity limit is not to be exceeded by any transmitter-receiver-amplifier combination. The consequence of this is that the individual components must each involve a correspondingly close tolerance and that such a close tolerance is also necessary for the circuitry thereof. If in an optronic fuse system an avalanche photodiode (APD) is used as the receiver, the gain of the avalanche effect can be only very inaccurately set, which means that adjustment becomes still more important. Hitherto, laser-trimmable thick-film resistors were usually employed for that adjustment procedure, if the situation involves large-scale mass production of the optronic fuse system, as has been mentioned above. In the case of small-scale series production, the usual procedure adopted involves individual fitment with the appropriate resistors, as has also already been referred to above. Irrespective of whether the situation involves small-scale series production or large-scale series production, hitherto a so-called closed loop operation must be used for adjustment purposes, that is to say the entire fuse system or the entire sensor has to be fitted and set in operation in order to be able to implement the adjustment procedure. Consequently adjustment can only be implemented at a very late stage in the assembly or manufacturing chain. That means that protective coatings can be only partially applied to the components to be adjusted or that the protective coatings have to be applied manually after the adjustment procedure has been carried out. Manual fitment, the operation of applying the protective sheathings and the necessary quality assurance procedures mean that relatively high manufacturing costs are incurred with such known optronic fuse systems. In addition the electromechanical design is limited because the components to be adjusted must be accessible for adjustment purposes in the installed condition.

Those shortcomings are advantageously eliminated by means of the method according to the invention. In the case of optronic fuse systems according to the invention which are already equipped with a controller, preferably with a flash memory, discrete regulation of the bias voltage of the APD by way of a temperature compensation network is replaced by regulation by way of said controller. In that situation, the controller ascertains the temperature of the APD and specifically regulates the bias voltage thereof in such a way that the sensitivity corresponds to the reference sensitivity, at any temperature. That regulation can advantageously also be used for trimming sensitivity. In that case, in the trimming procedure, the individual bias voltage of the APD is ascertained in such a way that the sensitivity of the sensor corresponds to the reference sensitivity. In operation of the fuse system, starting from the working point of the temperature curve, which corresponds to normal sensitivity, temperature compensation can then be effected again. In that case, in the adjustment procedure, the controller is desirably loaded with a basic operating software which sets the APD to a medium gain factor.

To carry out the method according to the invention, the optronic fuse system is set in operation in the adjustment procedure and the signal levels achieved, that is to say the sensitivity, are measured. The gain which is a function of the bias voltage of the APD can be calculated from the respectively measured value. The controller can then be programmed with the bias voltage.

It will be seen from the foregoing that an analog adjustment procedure as has hitherto been implemented is advantageously no longer required. A further advantage is that any ageing of the sensor arrangement can also be compensated at any time by a re-programming procedure.

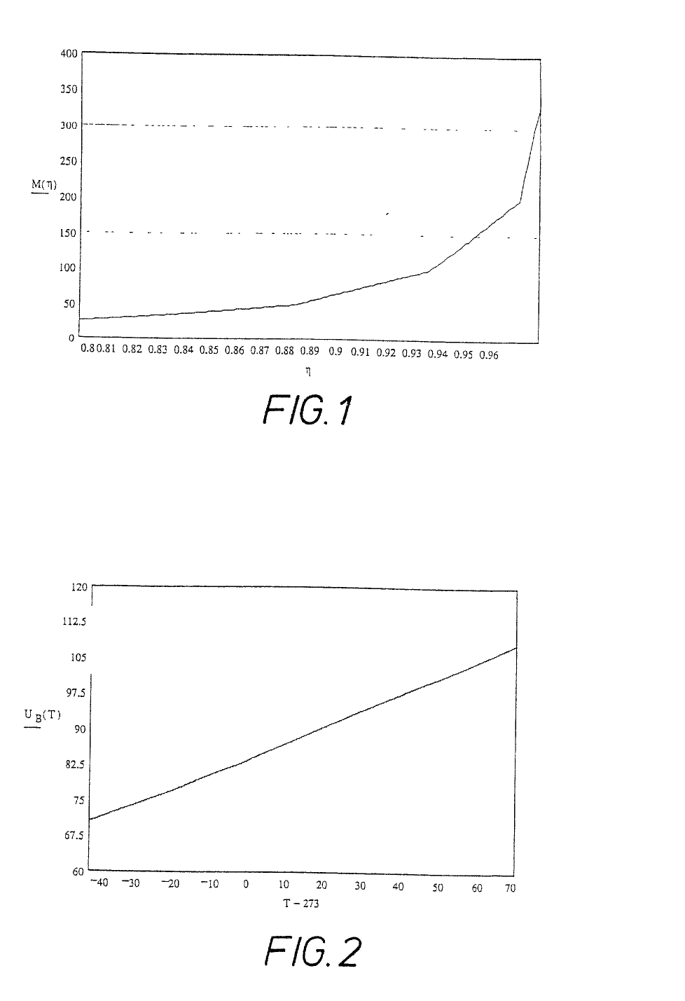

FIGS. 1 and 2 which are described hereinafter serve to further set forth the concept of the invention.

FIG. 1 shows the functional relationship between the ratio η between the bias voltage to the breakdown voltage and the APD-gain M(η), and

FIG. 2 shows the functional relationship between the temperature (T) and the bias voltage U_{B}(T).

As shown in FIG. 1 the inherent gain of the APD (avalanche effect) is to be set by way of the ratio η of the bias voltage to the breakdown voltage. If the reception system is too insensitive, the ratio η has to be increased in the trimming operation. If conversely the reception system is too sensitive, the ratio η has to be reduced in the trimming operation.

Since, as can be seen from FIG. 2, the breakdown voltage U_{B} is heavily dependent on the temperature (T-273), the ratio η (see FIG. 1) must be suitably re-adjusted upon a change in temperature.

1. A method of adjusting the sensitivity of and stabilising an optronic fuse system which has a controller and as a receiver an APD, characterised in that the controller ascertains the temperature of the APD and regulates the bias voltage of the APD in such a way that the sensitivity corresponds to its reference sensitivity at any temperature.

2. A method according to claim 1 characterised in that the regulation operation is also used for trimming sensitivity insofar as in the trimming operation the individual bias voltage of the APD which corresponds to the normal sensitivity of the system is ascertained.

3. A method according to claim 2 characterised in that, in operation of the fuse system, starting from the working point of the temperature curve of the APD, which corresponds to normal sensitivity, a temperature compensation operation is then carried out.

4. A method according to one of claims 1 to 3 characterised in that in the adjustment operation the controller is loaded with a basic operating software which sets the APD to a medium gain factor.
